(19) United States
(12) Patent Application Publication
(10) Pub. No.: US 2022/0266072 A1
(43) Pub. Date: Aug. 25, 2022

(54) Safety Harness Assembly

(71) Applicant: Tethrd LLC, Carver, MN (US)

(72) Inventors: Walter Ernest Power, II, Jordan, MN (US); Gregory Alan Godfrey, Richmond Hill, GA (US); Carl Eugene Kossuth, III, St. James, MN (US)

(73) Assignee: Tethrd, LLC, Carver, MN (US)

(21) Appl. No.: 17/182,616

(22) Filed: Feb. 23, 2021

(51) Int. Cl. A62B 35/00

(52) U.S. Cl. CPC A62B 35/0012

(57) ABSTRACT

A safety harness assembly includes a saddle which supports a person who is positioned in a tree. The saddle includes a primary support which is designed to hold at least 80% of a total load held by the saddle when the saddle is fully supporting a person from a tree line. The primary support includes an upper strap and a lower strap secured together to form a closed loop. The closed loop includes a first lateral edge and a second lateral edge to which is secured a bridge line that in turn can be secured to a tree. The lower and upper straps form a cradle for the buttocks. A secondary support is attached to the primary support and is configured to retain the primary support on the person. The upper and lower straps of the primary support are webbing comprised of UHMWPE.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR Not Applicable

### BACKGROUND OF THE INVENTION

### (1) Field of the Invention.

The disclosure relates to tree harness device and more particularly pertains to a new tree harness device for supporting a hunter in a tree wherein the hunter will typically be supported by a platform mounted in the tree. Such environments typically utilize a tree rope secured to the tree, which is in turn secured to the harness device. The harness device is then worn by the hunter to prevent the hunter from falling to the ground such the hunter fall from the platform or fall while climbing.

### (2) Description of Related Art including information disclosed under 37 CFR 1.97 and 1.98.

The prior art relates to tree harness devices which are typically constructed of conventional thermoplastic polyamide webbings, such as nylon. Nylon, for example, has traditionally been used for its strength and because it is a relatively inexpensive, and widely available, material. However, nylon abrades over time and this wearing of the material may lead to fatigue points. Because a hunter will often wear a harness while walking through underbrush and will specifically be worn while tree climbing, the nylon webbing will often rub against bark, branches, bristles, and other abrading material.

Furthermore, nylon harnesses can easily become entangled as the webbing is taken off and stored.

### BRIEF SUMMARY OF THE INVENTION

For the reasons stated above, the present invention utilizes an ultra high molecular weight polyethylene (UHMWPE) webbing. Such material has been avoided for saddles due to its difficulty to work with. Specifically, this material is hard to manipulate because it is slippery to grip, is difficult to cut, clean cuts are not easily achieved, and wear on machinery is increased because of the strength of the material. UHMWPE also has a lower melting point than conventional webbing which requires designs that minimize friction that can lead to catastrophic failure. Saddle designs using UHMWPE must also take into account fall force maximums as this material does stretches less than traditional materials which would create greater “felt shock” during a fall. However, while more expensive than nylon webbing, UHMWPE is resistant to abrasion and is more lightweight then conventional nylon webbing. Also, the low coefficient of friction which makes it slippery to grip, also enables bark and other abrasives to easily slide over the UHMWPE without causing wear while preventing the material from snagging on abrasive surfaces. This feature also makes UHMWPE more resistant to entanglement and is stronger than nylon. Thus, while UHMWPE creates a higher cost of manufacture than using nylon, it has been determined that utilizing this material provides for particular advantages over prior art structures.

An embodiment of the disclosure meets the needs presented above by generally comprising a saddle configured to receive the buttocks of a person. The saddle includes a primary support configured to support over 80% of a load held by the saddle when the saddle is fully supporting a person from a tree line. The primary support includes an upper strap and a lower strap secured together to form a closed loop. The closed loop includes a front side, a back side, a first lateral edge and a second lateral edge. The first and second lateral edges are configured to engage a bridge line such that the bridge line can be secured to a tree. The lower strap is positionable below the buttocks of a person and the upper strap is positionable above the buttocks such that the primary support forms a cradle for the buttocks. A secondary support is attached to the primary support and is configured to retain the primary support on the person. The upper and lower straps of the primary support are constructed of a webbing comprising UHMWPE.

In another embodiment of the disclosure a saddle is configured to receive the buttocks of a person wherein the saddle includes a primary support configured to support over 80% of a load held by the saddle when the saddle is fully supporting a person from a tree line. The primary support includes an upper strap and a lower strap secured together to form a closed loop. The closed loop includes a front side, a back side, a first lateral edge and a second lateral edge, the first and second lateral edges is configured to engage a bridge line such that the bridge line can be secured to a tree. The lower strap is positionable below the buttocks of a person and the upper strap is positionable above the buttocks such that the primary support forms a cradle for the buttocks. A secondary support is attached to the primary support and is configured to retain the primary support on the person. A tertiary support is attached to the primary support and is configured to engage a lineman's rope. The tertiary support including a pair of lineman loops is attached to the back side of the primary support. At least one of the primary, secondary or tertiary supports is a webbing comprising UHMWPE.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear view of a safety harness assembly according to an embodiment of the disclosure.

FIG. 2 is a front view of an embodiment of the disclosure.

FIG. 3 is a side view of an embodiment of the disclosure.

FIG. 4 is a side in-use view of an embodiment of the disclosure.

### DETAILED DESCRIPTION OF THE INVENTION

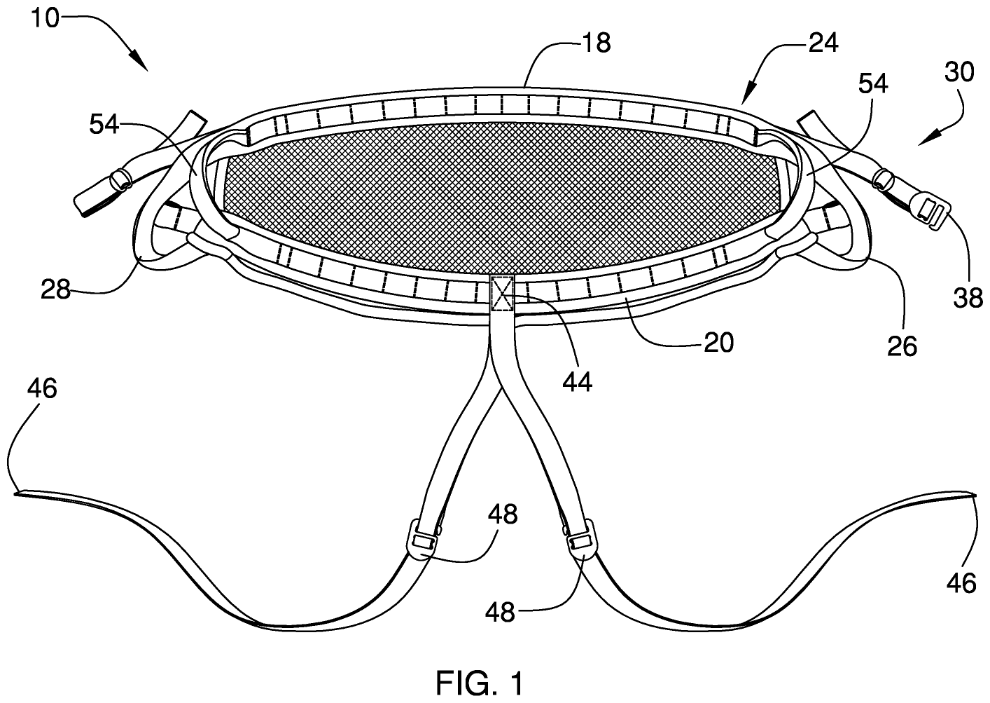

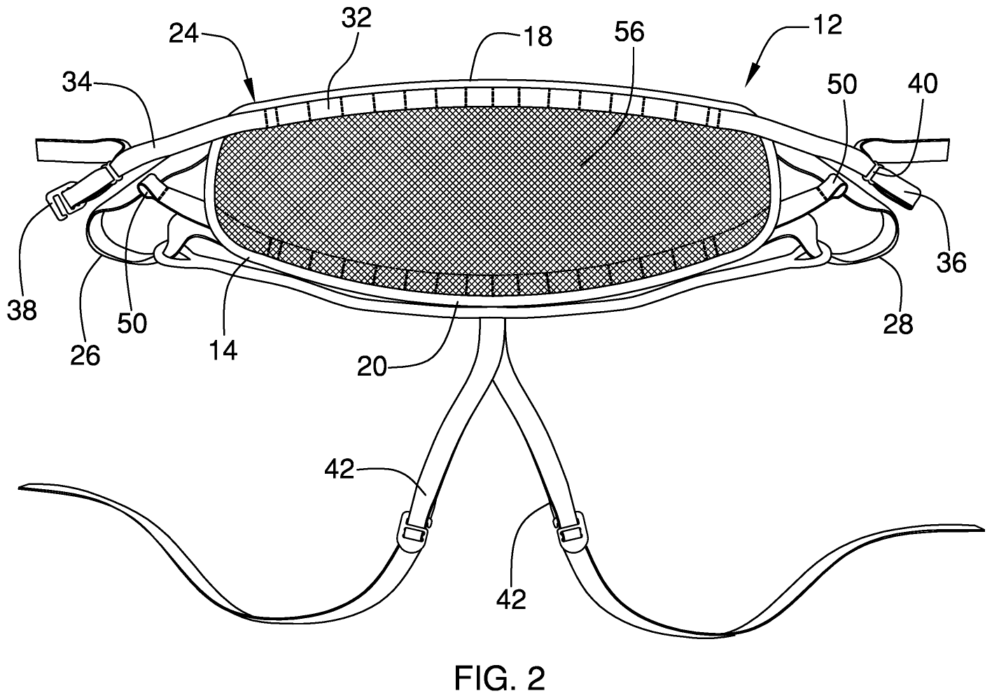

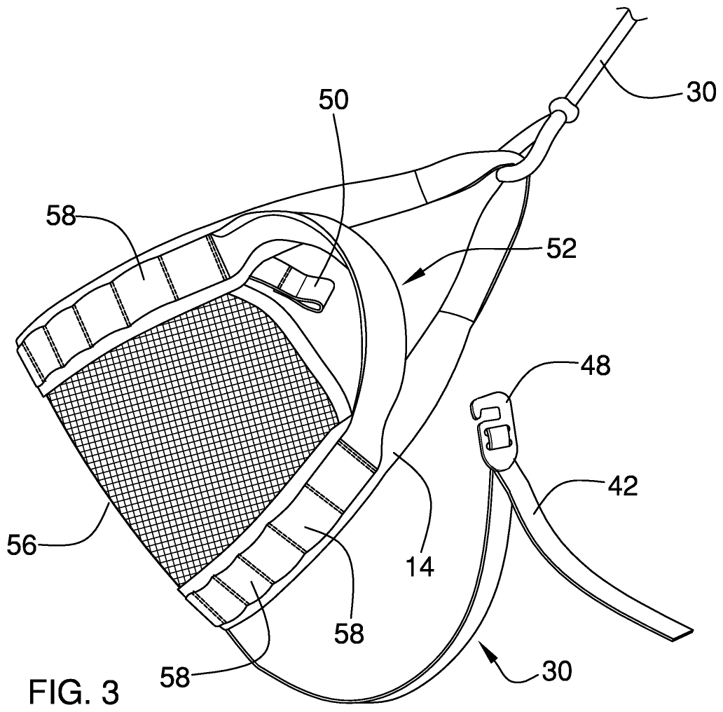

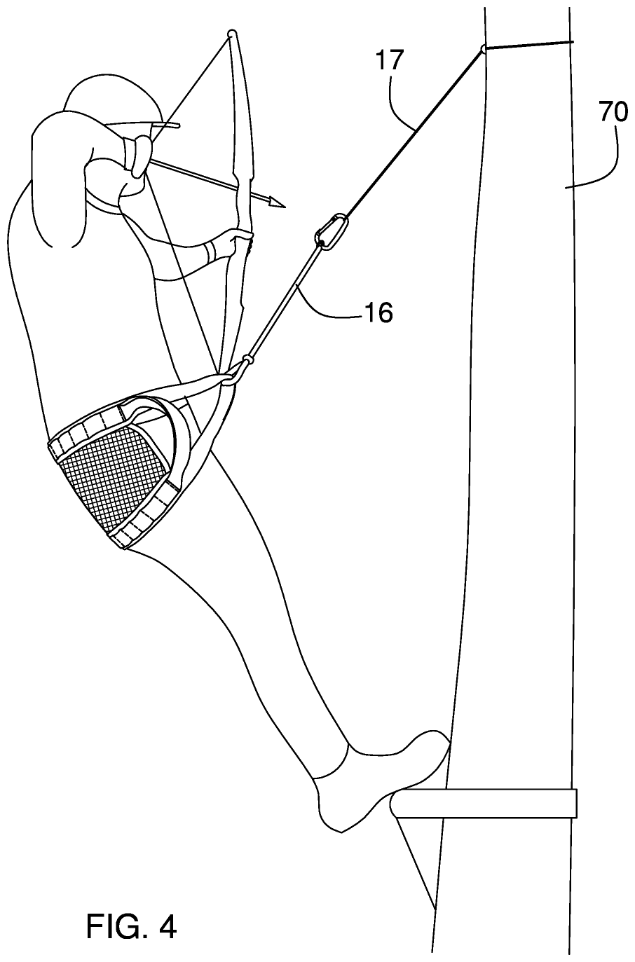

With reference now to the drawings, and in particular to FIGS. 1 through 4 thereof, a new tree harness device embodying the principles and concepts of an embodiment of the disclosure and generally designated by the reference numeral 10 will be described.

As best illustrated in FIGS. 1 through 4, the safety harness assembly 10 generally comprises a saddle 12 configured to receive the buttocks of a person. The saddle 12 has a generally conventional shape and includes a primary support 14 configured to support over 80% of a load held by the saddle 12 when the saddle 12 is fully supporting a person. That is, typically, the saddle 12 is secured to a bridge rope 16 which would thereafter be secured to a tree line 17 attached to a tree 70. The saddle 12 supports the person while the person is hunting from a tree 70, for example, and will prevent their falling to the ground should the person slip from their perch. In the event of a fall, the primary support 14 will hold at least 80%, and may sustain more than 90%, of the person's load, or weight including all gear, as the bridge rope 16 is pulled taut. Thus, depending on the distance the person falls before the bridge rope 16 is pulled taut, the load sustained by the primary support 14 may be several times the mass of the person due to gravitational effects.

The primary support 14 includes an upper strap 18 and a lower strap 20 secured together to form a closed loop. The upper 18 and lower 20 straps may be formed into a continuous loop, wherein the terms upper strap 18 and lower strap 20 are used simply to facilitate description of the assembly 10. The closed loop has a front side 22, a back side 24, a first lateral edge 26 and a second lateral edge 28. The first 26 and second 28 lateral edges are configured to engage the bridge line 16 such that the bridge line 16 can be secured to a tree, and more typically a tree rope attached to the tree. The lower strap 20 is positionable below the buttocks of a person and the upper strap is positionable above the buttocks such that the primary support 14 forms a cradle for the buttocks. The first 26 and second 28 lateral edges are arcuate such that the primary support 14 generally has an elongated oval shape.

The saddle 12 includes a secondary support 30 that is attached to the primary support 14 and is configured to retain the primary support 14 on the person. The secondary support 30 includes a belt strap 32 having a first free portion 34 extending away from the first lateral edge 26 and a second free portion 36 extending away from the second lateral edge 28. Each of the first 34 and second 36 free portions is attached to the upper strap 18. A coupler 38 releasably couples together the first 34 and second 36 free portions to form a waist belt configured to extend around a waist of the person. Cinching members 40 may be positioned on the belt strap 32 to adjust its circumference. As can be seen in the Figures, the first 34 and second 36 free portions may be comprised of a single strap secured to and extending along front side 22 of the upper strap 18.

The secondary support 30 further includes a pair of leg straps 42. The leg straps 42 each have an attached end 44 attached to the primary support 14 and a free end 46 extending downwardly away from the primary support 14. Each of the leg straps 42 is configured to be extended around a different one of a pair of legs of the person. The leg straps 42 each include a securing member 48 to releasably secure the leg straps in a closed loop. The securing member 48 may be attached to the lower strap 20, the upper strap 18, the first 34 or second 36 free portions or it may be attached to securing points 50 attached to the primary support 14.

A tertiary support 52 is attached to the primary support 14 and is configured to engage a conventional lineman's rope. A lineman's loop is used during the ascending and descending of a tree. The lineman's rope is extended around the tree 70 and through the tertiary support 52 and will frictionally engage the tree 70 such that the climber can lean away from the tree 70 as they climb with the lineman's rope providing a grip between the climber and the tree 70. Once the primary support 14 is used with the tree line 17 to support the climber's weight, the lineman's rope is removed from the tertiary support 52. The tertiary support 52 includes a pair of lineman loops 54 that are attached to the back side 22 of the primary support 14. Each of the first 26 and second 28 lateral edges has one of the lineman loops 54 positioned adjacent thereto. The lineman loops 54 may each comprise a webbing, i.e. strap material of woven strands, having a first end attached to the upper strap 18 and a second end attached to the lower strap 20, or the lineman loops 54 may be formed by a continuous loop attached to the upper 18 and lower 20 straps.

The upper 18 and lower 20 straps of the primary support 14 are a webbing which comprises a polyethylene, and in particular ultra high molecular weight polyethylene, typically known as UHMWPE. This material characteristically includes extremely long chains of polyethylene having 100,000 to 250,000 monomer units per molecule. Such material is available from numerous suppliers such as, for example, Sturges Manufacturing Co., Inc., 2030 Sunset Avenue, Utica, N.Y., and often sold under the trade name Dyneema. This material may be blended with other materials; however, the webbing may consist solely of UHMWPE.

The secondary support 30 and the tertiary support 52 may also be comprised of UHMWPE. The secondary support 30 may alternatively be comprised of different materials which do not require the strength to the primary support. However, because of the weight to strength advantages of UHMWPE to conventional webbing material used for saddles, UHMWPE is also preferred. In addition to its strength advantages, UHMPWE is also resistant to abrasion, does not readily absorb water and has a low coefficient of friction. Having a low coefficient of friction reduces the chances of the webbing of the primary 14 and secondary 30 supports from tangling and from snagging.

The saddle 12 may include other elements to improve the functionality and comfort of the saddle 12. For example, a mesh material 56 may be attached to and extend between the upper 18 and lower 20 straps. The mesh material 56 is used to add comfort by displacing the user's weight as well as retain the upper 18 and lower 20 straps at a selected distance from each other. As is shown in the Figures, MOLLE (modular lightweight load-carrying equipment) connectors/receivers 58 may be positioned on the assembly 10 and may be formed from webbing used to form the tertiary support 52.

In use, the assembly 10 is used in a conventional manner as typical saddles. Once placed on a person, the UHMPWE material creates a lightweight saddle that can be worn comfortably while moving through a stand of trees. The bridge rope 16 is tied to a conventional tree line and the person climbs the tree to their platform. Should the person fall, the saddle 12 will catch the person to prevent their injury.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A safety harness assembly configured to be worn by a person and engaged with a bridge line, the safety harness including:
a saddle configured to receive the buttocks of a person, the saddle including:
a primary support configured to support over 80% of a load held by the saddle when the saddle is fully supporting a person from a tree line, the primary support including an upper strap and a lower strap secured together to form a closed loop, the closed loop including a front side, a back side, a first lateral edge and a second lateral edge, the first and second lateral edges being configured to engage a bridge line such that the bridge line can be secured to a tree, the lower strap being positionable below the buttocks of a person and the upper strap being positionable above the buttocks such that the primary support forms a cradle for the buttocks;
a secondary support being attached to the primary support and being configured to retain the primary support on the person;
the upper and lower straps of the primary support being a webbing comprising UHMWPE.

2. The safety harness assembly according to claim 1, wherein the secondary support includes a belt strap including a first portion extending away from the first lateral edge and a second free portion extending away from the second lateral edge, each of the first and second free portions being attached to the upper strap, a coupler releasably coupling together the first and second free portions to form a waist belt configured to extend around a waist of the person.

3. The safety harness assembly according to claim 2, wherein the secondary support includes a pair of leg straps each having an attached end being attached to the primary support and a free end extending downwardly away from the primary support, each of the leg straps being configured to be extended around a different one of a pair of legs of the person, each of the leg straps including a securing member to releasably secure the leg straps in a closed loop.

4. The safety harness assembly according to claim 1, wherein the secondary support includes a pair of leg straps each having an attached end being attached to the primary support and a free end extending downwardly away from the primary support, each of the leg straps being configured to be extended around a different one of a pair of legs of the person, each of the leg straps including a securing member to releasably secure the leg straps in a closed loop.

5. The safety harness assembly according to claim 1, wherein the secondary support comprises UHMWPE.

6. The safety harness assembly according to claim 3, wherein the leg straps and the belt strap each comprises UHMWPE.

7. The safety harness assembly according to claim 1, further including a tertiary support being attached to the primary support and being configured to engage a lineman's rope, said tertiary support comprising UHMWPE.

8. The safety harness assembly according to claim 7, wherein the tertiary support includes a pair of lineman loops being attached to the back side of the primary support, each of the first and second lateral edges having one of the lineman loops positioned adjacent thereto, each of the lineman loops comprising a webbing having a first end attached to the upper strap and a second end attached to the lower strap.

9. The safety harness assembly according to claim 5, further including a tertiary support being attached to the primary support and being configured to engage a lineman's rope, said tertiary support comprising UHMWPE.

10. The safety harness assembly according to claim 9, wherein the tertiary support includes a pair of lineman loops being attached to the back side of the primary support, each of the first and second lateral edges having one of the lineman loops positioned adjacent thereto, each of the lineman loops comprising a webbing having a first end attached to the upper strap and a second end attached to the lower strap.

11. The safety harness assembly according to claim 1, further including a mesh material being attached to and extending between the upper and lower straps.

12. The safety harness assembly according to claim 5, further including a mesh material being attached to and extending between the upper and lower straps.

13. The safety harness assembly according to claim 7, further including a mesh material being attached to and extending between the upper and lower straps.

14. A safety harness assembly configured to be worn by a person and engaged with a bridge line, the safety harness including:
a saddle configured to receive the buttocks of a person, the saddle including:
a primary support configured to support over 80% of a load held by the saddle when the saddle is fully supporting a person from a tree line, the primary support including an upper strap and a lower strap secured together to form a closed loop, the closed loop including a front side, a back side, a first lateral edge and a second lateral edge, the first and second lateral edges being configured to engage a bridge line such that the bridge line can be secured to a tree, the lower strap being positionable below the buttocks of a person and the upper strap being positionable above the buttocks such that the primary support forms a cradle for the buttocks;
a secondary support being attached to the primary support and being configured to retain the primary support on the person;
a tertiary support being attached to the primary support and being configured to engage a lineman's rope, the tertiary support including a pair of lineman loops being attached to the back side of the primary support; and
at least one of said primary, secondary or tertiary supports being a webbing comprising UHMWPE.

15. The safety harness assembly according to claim 14, wherein each of said primary and tertiary supports comprises UHMWPE.

16. The safety harness assembly according to claim 14, wherein each of said primary, secondary and tertiary supports comprises UHMWPE.

17. The safety harness assembly according to claim 14, further including a mesh material being attached to and extending between the upper and lower straps.

18. The safety harness assembly according to claim 14, wherein the secondary support includes a belt strap including a first portion extending away from the first lateral edge and a second free portion extending away from the second lateral edge, each of the first and second free portions being attached to the upper strap, a coupler releasably coupling together the first and second free portions to form a waist belt configured to extend around a waist of the person.

19. The safety harness assembly according to claim 18, wherein the secondary support includes a pair of leg straps each having an attached end being attached to the primary support and a free end extending downwardly away from the primary support, each of the leg straps being configured to be extended around a different one of a pair of legs of the person, each of the leg straps including a securing member to releasably secure the leg straps in a closed loop.

20. A safety harness assembly configured to be worn by a person and engaged with a bridge line, the safety harness including:
a saddle configured to receive the buttocks of a person, the saddle including:
a primary support configured to support over 80% of a load held by the saddle when the saddle is fully supporting a person from a tree line, the primary support including an upper strap and a lower strap secured together to form a closed loop, the closed loop including a front side, a back side, a first lateral edge and a second lateral edge, the first and second lateral edges being configured to engage a bridge line such that the bridge line can be secured to a tree, the lower strap being positionable below the buttocks of a person and the upper strap being positionable above the buttocks such that the primary support forms a cradle for the buttocks;
a secondary support being attached to the primary support and being configured to retain the primary support on the person, the secondary support including:
a belt strap including a first free portion extending away from the first lateral edge and a second free portion extending away from the second lateral edge, each of the first and second free portions being attached to the upper strap, a coupler releasably coupling together the first and second free portions to form a waist belt configured to extend around a waist of the person;
a pair of leg straps each having an attached end being attached to the primary support and a free end extending downwardly away from the primary support, each of the leg straps being configured to be extended around a different one of a pair of legs of the person, each of the leg straps including a securing member to releasably secure the leg straps in a closed loop;
a tertiary support being attached to the primary support and being configured to engage a lineman's rope, the tertiary support including a pair of lineman loops being attached to the back side of the primary support, each of the first and second lateral edges having one of the lineman loops positioned adjacent thereto, each of the lineman loops comprising a webbing having a first end attached to the upper strap and a second end attached to the lower strap;
the upper and lower straps of the primary support being a webbing comprising of UHMWPE;
the secondary support comprising of UHMWPE;
the tertiary support comprising UHMWPE; and
a mesh material being attached to and extending between the upper and lower straps.
